(19) United States
(12) Patent Application Publication
(10) Pub. No.: US 2012/0287460 A1
(43) Pub. Date: Nov. 15, 2012

(54) METHODS AND SYSTEMS OF MOBILE DISCOVERY AND PRINTING CONFIGURATION

(76) Inventors: Lyle Bruce McMillin, Georgetown, KY (US); Forrest Lane Steely, Lexington, KY (US); Carl Clifford Nieland, Lexington, KY (US); Kenneth R. Woodruff, Lexington, KY (US); Joel Young, Caneyville, KY (US)

(21) Appl. No.: 13/103,399

(22) Filed: May 9, 2011

(51) Int. Cl. G06K 15/02

(52) U.S. Cl. 358/1.15

(57) ABSTRACT

A method for configuring a mobile device that includes retrieving encoded access information from an imaging device, decoding the encoded access information, and configuring the mobile device to communicate with the imaging device in accordance with the decoded access information. The imaging device and the mobile device may operate on different subnets of a network.

### CROSS REFERENCE TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC

None.

### BACKGROUND

1. Technical Field

The present disclosure relates to printing, and, more particularly, to mobile printing.

2. Description of the Related Art

There is an ongoing trend in many organizations, such as those in the health care industry, to shift towards mobile computing as a means for conducting several core business processes using computing devices. As more and more users take advantage of their newfound mobility with the use of mobile devices, they may have content that they need to print using imaging devices that may be physically close to them. However, these users may not have a method to determine the imaging device's address or print capabilities. Moreover, the users' physical location may frequently change throughout the day, making them closer to other imaging devices that may be more convenient to use at a particular place and time.

One solution to establish connectivity is to establish a physical link to the imaging device through a USB, Firewire, parallel or serial connection. However, using physical connections for the discovery and configuration processes may be undesirable and time-consuming, and it may even be impossible for many mobile devices. Establishing a physical connection between an imaging device and a mobile device may also prevent mobile devices from performing business processes. What is needed is a method for discovering imaging devices by a mobile device wirelessly.

Existing methods that solve this problem use wireless device discovery through a variety of protocols and methods. In one known method, the mobile smart device sends out a local network query to a standard port, and imaging devices that respond are identified to the user. The user of the mobile device then selects an imaging device and accesses the capabilities of the imaging device allowing the user to print a document using the selected imaging device. One shortcoming of this wireless device discovery method, however, is that to devices which may not be physically close to the user, or may not be the imaging device that the user wishes to use, may be identified or shown to the user. This method may lead to problems in determining which one of the listed imaging devices is the device that the user wants to use to print documents.

Another known method of wireless device discovery is through the use of service discovery protocols. Typically, however, service discovery protocols only search the local subnet for imaging devices. If the mobile device is operating in a particular local wireless network, the service lookup protocol will only find imaging devices on a local subnet of that network. This limits the discovery only to imaging devices with wireless capability. Since the network typically segments the wireless portion of the network in a different segment than the wired network and the discovery protocol does not bridge across subnets, this method fails to discover a physically adjacent or closer network imaging device attached to the wired segment of the network.

In another service discovery protocol method, multiple subnets may be searched. However, such subnets had to be identified by the user beforehand (i.e., the user had to configure the subnets to search).

Other existing methods for wireless device discovery are solutions that allow users to authenticate themselves to an imaging device and retrieve their print jobs from a centralized queue on a specific network. However, there are limitations to these solutions that make them less than desirable in many situations. For example, mobile device users may have to connect to multiple networks throughout the day, but the centralized queue is limited to a single specific network. Another issue with this method is that users are unnecessarily required to authenticate themselves every time they print. Thus, for users who spend a significant amount of time in one network, they are bothered by the need to authenticate themselves every time they need to print to an imaging device that is in close proximity.

Accordingly, there is a need to allow mobile device users to easily set up a printer connection to an imaging device in their immediate area without the need for a complicated server-based queue or a server-based management system.

There is a need for a solution that will allow users of mobile devices to quickly print content and easily change imaging devices without the need to install multiple devices. There is a need for a solution that allows mobile device users to easily and quickly print to anywhere in their organization. By obtaining the access information of a wired network imaging device through decoded access information such as barcode or RFID tag, the user of a mobile device can easily direct print jobs to the imaging device even if the imaging device belongs to a different network subnet.

### SUMMARY

According to one example embodiment of the present disclosure, there is provided a method for configuring a mobile device. The mobile device may retrieve encoded access information from an imaging device, decode the encoded access information, and configure the mobile device to communicate with the imaging device in accordance with the decoded access information. The imaging device and the mobile device may operate on different subnets of a network.

In one aspect, the encoded access information may be retrieved from a barcode. The mobile device may scan the barcode using a barcode scanner application installed in the mobile device or capture an image of the barcode using a camera installed in the mobile device. Upon retrieving the device access information, the mobile device may decode the encoded access information using an application such as a barcode reader or scanner installed in the mobile device. The mobile device may then be configured to communicate with the imaging device in accordance with the decoded access information. The barcode scanned by the mobile device may be visually displayed on the imaging device or may be printed on a media.

In another aspect, the encoded access information may be retrieved from an RFID tag using an RFID scanner installed on the mobile device. The device access information from the RFID tag may then be interpreted to obtain the access data of the imaging device that will be used to configure the printing subsystem of the mobile device to communicate with the imaging device in accordance with the imaging device access information.

Aspects of the disclosure described below may apply to the method for configuring the mobile device to communicate with an imaging device using a barcode to acquire imaging device access information and the method for configuring the mobile device to communicate with an imaging device by acquiring information using an RFID tag. The to method performed by computer executable instructions contained in a non-transitory computer-readable medium may also be applied with the aspects of the disclosure described below.

In one aspect of the present disclosure, the mobile device and the imaging device with which the mobile device may be configured to communicate with may operate on different subnets of a network. The imaging device may be connected to the network using a wired or wireless network connection. According to an aspect of the disclosure the encoded access information may include an imaging device network identifier such as, but is not limited to, an IP address, a hostname, a network print queue address or a nickname of the imaging device. Alternatively, the encoded access information may include imaging device status, imaging device options and imaging device configuration data. In an aspect of the disclosure, the mobile device may perform a database or table lookup to obtain the imaging device network identifier if the encoded access information includes the imaging device name. Alternatively, if the encoded access information includes a nickname of the imaging device, the mobile device may perform a database or table lookup to obtain the IP address, the hostname or any network identifier of the imaging device.

In another aspect of the disclosure, decoding the encoded access information may include extracting the imaging device network identifier. In one aspect of the disclosure, interpreting the imaging device access information may include obtaining the network location of the imaging device. Alternatively, interpreting the imaging device access information may include identifying the network location of the imaging device.

Other embodiments, objects, features and advantages of the disclosure will become apparent to those skilled in the art from the detailed description, the accompanying drawings and the appended claims.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 is one example embodiment of a document processing system including an imaging device and a mobile device.

FIG. 2 is one example flowchart of a method for configuring a mobile device to communicate with an imaging device, according to one example embodiment.

FIG. 3 is one example flowchart of a method for acquiring device access information for use in conjunction with the method of FIG. 2.

FIG. 4 is a second example flowchart of a method for acquiring device access information for use in conjunction with the method of FIG. 2.

### DETAILED DESCRIPTION OF THE DRAWINGS

The following description and drawings illustrate embodiments sufficiently to enable those skilled in the art to practice the present disclosure. It is to be understood that the disclosure is not limited to the details of construction and the arrangement of components set forth in the following description or illustrated in the drawings. The disclosure is capable of other embodiments and of being practiced or of being carried out in various ways. For example, other embodiments may incorporate structural, chronological, electrical, process, and other changes. Examples merely typify possible variations. Individual components and functions are optional unless explicitly required, and the sequence of operations may vary. Portions and features of some embodiments may be included in or substituted for those of others. The scope of the application encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to to physical or mechanical connections or couplings. Further, the terms “a” and “an” herein do not denote a limitation of quantity, but rather denote the presence of at least one of the referenced item.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block of the diagrams or combinations of blocks in the diagrams discussed in detail in the descriptions below.

These computer program instructions may also be stored in a non-transitory computer-readable memory that may direct a computer or other programmable data processing apparatus to function in a particular manner, such that the instructions stored in the computer-readable memory produce an article of manufacture including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, can be implemented by special purpose hardware-based computer systems that perform the specified functions or steps, or combinations of special purpose hardware and computer instructions.

Disclosed are systems and methods for mobile discovery and mobile printing configuration. According to one example embodiment of the present disclosure, a user of a mobile device may approach an imaging device that the user wishes to access for printing one or more files and acquire device access information from it. The device access information may include information regarding the imaging device which may be used in configuring a mobile device or creating a communication link between the mobile device and the imaging device in order to send print jobs from the mobile device to the imaging device. In order to print one or more files, there may be no need to establish a direct communications link between the mobile device and the imaging device. The one or more files may be processed through an imaging device or printer driver associated with the imaging device, transferred to the imaging device and subsequently printed. The mobile device may transfer or communicate the one or more files using conventional mobile printing techniques which allow users to print the one or more files without having to be in close proximity from a traditional network or local printer. Mobile printing may be wireless and may use radio waves such as Bluetooth or 802.11 networking to communicate.

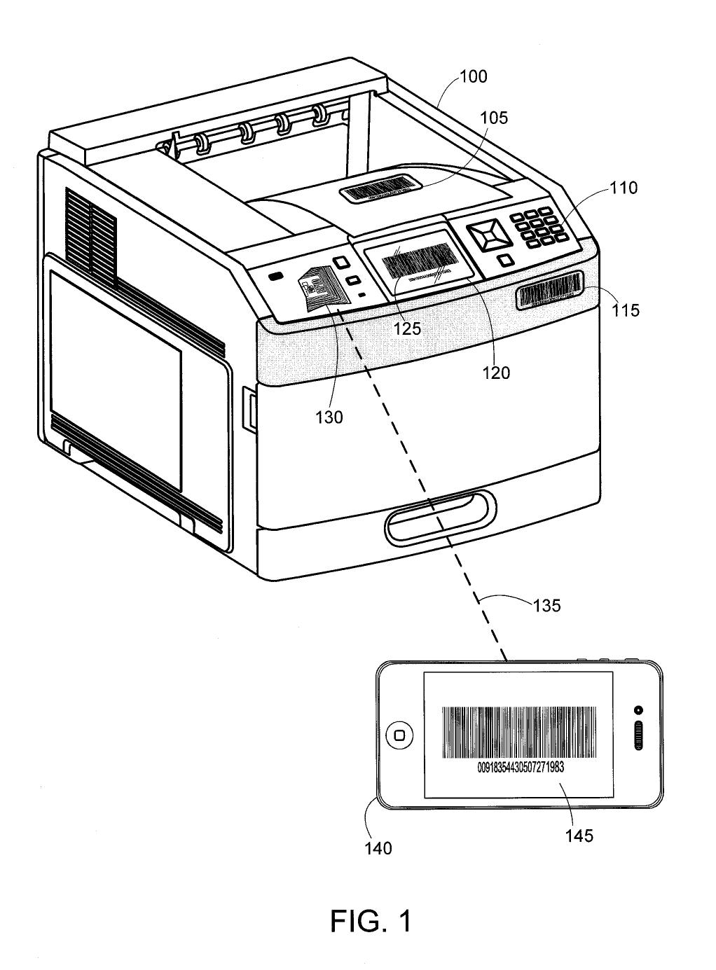

For purposes of the present disclosure, it will be appreciated that the mobile device may be any computing device that is portable, handheld or pocket-sized. A mobile device may include a display screen, a camera, and a barcode reader. In some embodiments, the mobile device may include an RFID scanner in addition to or in lieu of a barcode reader. The mobile device may also include a printer driver or file transfer application, such as a printing application, that enables it to communicate with an imaging device or send print jobs to an imaging device. Examples of mobile devices include, but are not limited to, mobile computers, laptop computers, tablet computers, mobile phones, personal digital assistants, portable media players, mobile internet devices, calculators, handheld game consoles, personal navigation devices, pagers, smart phones and enterprise digital assistants. Referring to FIG. 1, there is shown a document processing system including an imaging device 100 and a mobile device 140 according to one example embodiment of the present disclosure. The imaging device 100 may be any device capable of printing or producing a hard copy of a data file or document stored in an electronic form, such as a laser, inkjet or dot matrix printer or multi-function device that has the capability of performing other functions, such a faxing, e-mailing, scanning and/or copying, in addition to printing.

In one aspect, the imaging device 100 may include a processor in communication with a communications or user interface 120, a memory, and a scanning subsystem. The user interface may be a graphical user interface, a monitor, a series of buttons, a touch-sensitive to display panel, a voice-activated interface, a speaker or the like. It is also within the scope of this aspect to utilize a computer, such as personal computer, having a monitor as the user interface. In one aspect, the user interface may serve as input device for the imaging device 100.

The imaging device 100 may also have an input device 110. The input device 110 may be any device communicatively coupled to the imaging device 100 and capable of receiving inputs from a user. Some example input devices include, for example, a numeric keypad, a keyboard and a mouse. In some other example embodiments, the input device may be virtual, such as a virtual keyboard or menu selection displayed on imaging device communications interface 120. In still other example embodiments, the input device may not be part of the imaging device 100 but rather communicatively coupled, such as by a cable or wirelessly, to the imaging device 100.

The imaging device 100 may be connected to a network via one or more appropriate communications links (not shown), as will be understood by those of ordinary skill in the art. For example, the one or more communications links may be established by a direct cable connection, by a wireless connection, and/or by a network connection such as, for example, an Ethernet local area network (LAN) or wide area network (WAN). The imaging device 100 may also be in communication with a mobile device 140 via one or more appropriate communications links, as will be explained in greater detail below.

The imaging device 100 may include user interface or imaging device communications interface 120, a control unit (not shown), and a print engine (not shown). The control unit of the printer may include a barcode display application 125, and the barcode display application 125 may have a user interface capable of being displayed in the imaging device communications interface 120 of the imaging device. In some example embodiments, the imaging device 100 may have a radio frequency identification (RFID) tag 130. It will be understood that the barcode display application 125 may be a software application that are stored in memory associated with the control unit and executed by the control unit in accordance with programmed logic associated with the software application. The RFID tag 130 may be physically attached to the imaging device 100 or embedded into hardware components of the imaging device 100.

The imaging device communications interface 120 may allow the imaging device to 100 to be in communication with one or more mobile devices 140. As shown in FIG. 1, the mobile device 140 may be communicatively coupled to the imaging device 100 via a mobile device communication link 135. The mobile device 140 may be any mobile processing device such as, for example, a mobile telephone (e.g. a cell phone), a smart phone, a handheld computer, a personal digital assistance (PDA), a notebook computer or a remote processing device. The mobile device 140 may include a mobile device communications interface 145. Additionally, the mobile device 140 may also include at least one control unit (not shown) such as, for example, a processor that controls the operation of the mobile device 140.

The imaging device communications interface 120 may be configured to accommodate wireless communication with a mobile device 140 via the mobile device communication link 135. For example, the mobile device communication link 135 may be a any wireless connection such as Bluetooth, 802.11x, wireless Ethernet, and ultra-wideband. Such communication protocols may allow service discovery and file exchange between a mobile device 140 and the imaging device 100.

The print engine of the imaging device 100 (not shown) may include or incorporate appropriate print process hardware associated with the imaging device 100 that is configured to output printed pages from the imaging device 100. The print engine may be, for example, an ink jet print engine configured for forming an image on a sheet of print media, such as a sheet of paper, transparency or fabric. The print engine may include, for example, a reciprocating printhead carrier that is mechanically and electrically configured to mount and carry at least one micro-fluid ejection device (e.g., an inkjet printhead) coupled in fluid communication with an ink source. It will be appreciated that many different types of print engines may be utilized by the printer including, but not limited to, inkjet print engines, dot matrix print engines, and laser print engines.

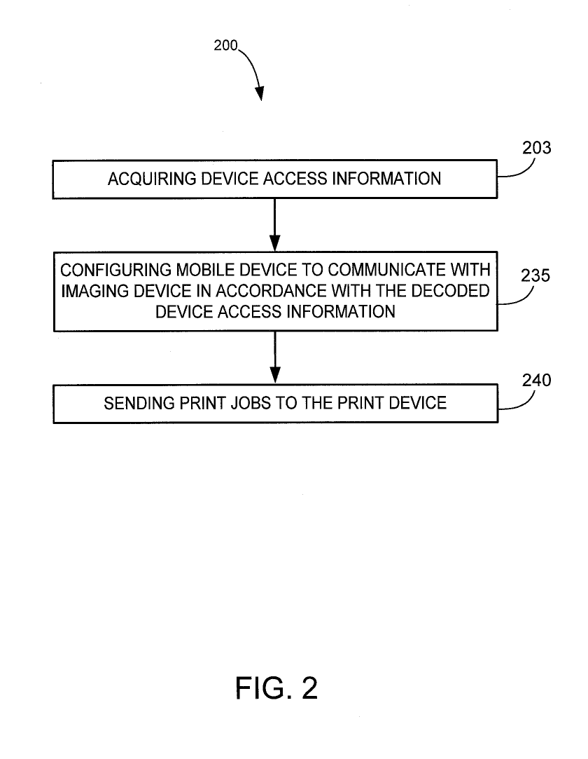

FIG. 2 is one example flowchart of a method 200 for ad hoc mobile discovery and printing configuration of a mobile device 140 in communication with an imaging device 100. The method of FIG. 2 may be initiated by a user of mobile device 140, and the mobile device 140 may control printing from the mobile device 140 while the imaging device 100 may function as a client that provides a printing service for the mobile device 140.

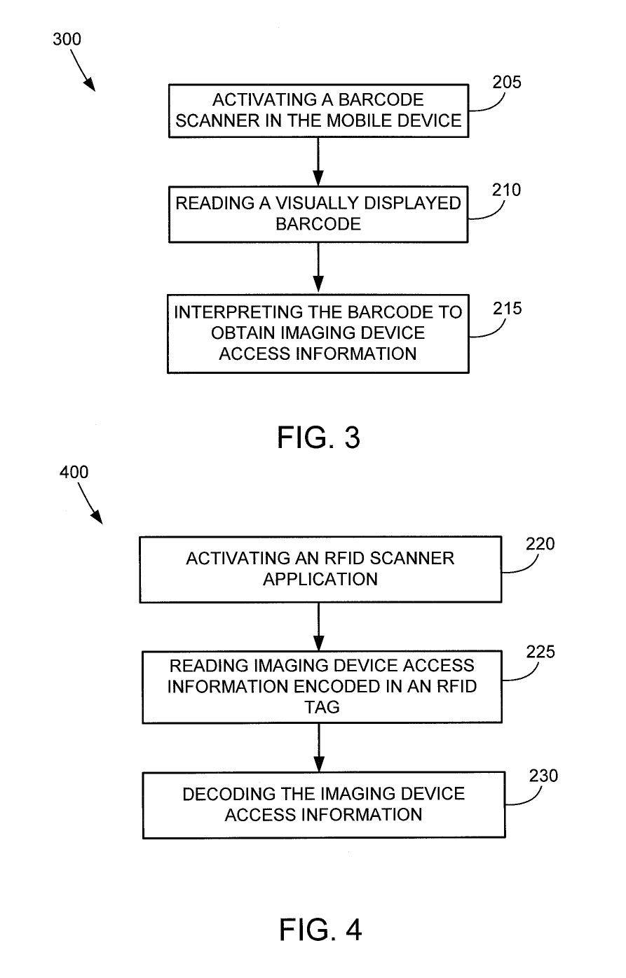

With reference to FIG. 2, at block 203, the mobile device 140 may acquire device access information from the imaging device 100. Various technologies for acquiring the to device access information may be used. In some example embodiments, acquiring the device access information of an imaging device 100 may be performed by activating a barcode scanner (not shown) in the mobile device 140 and acquiring the device access information using the barcode scanner, as explained in greater detail below with reference to FIG. 3. In other example embodiments, acquiring the device access information from an imaging device may be performed by activating a radio frequency identification (RFID) scanner application (not shown) in the mobile device 140 and acquiring the device access information using the RFID scanner, as explained in greater detail below with reference to FIG. 4. It will be appreciated by one of ordinary skill in the art that the device access information may be acquired using other technologies, such as optical character recognition, optical mark recognition, a magnetic card reader in still other example embodiments. In some example embodiments, the connection between the mobile device 140 and the imaging device 100 may be wireless or via an application running on the mobile device 140, such as a scanner application.

The device access information may take any form or be made out of any object desired by a user, provided the device access information is recognizable by the imaging device 100 and mobile device 140 for which it is designed or has a suitable communication mechanism embedded, attached or otherwise affixed to it. Device access information may also employ multiple means of recognition. In some example embodiments, device access information may be contained in a sheet of paper or other media containing a barcode, an RFID tag, fiducial mark or other predesignated symbol that indicates access information. In other example embodiments, device access information may be stored electronically on a computer-readable storage medium and accessed or communicated to the mobile device 100 using an electronic communications means, such as Bluetooth or Wi-Fi.

The device access information may include data necessary for the mobile device 140 to access and connect to the imaging device 100 automatically. The device access information may contain the network IP address or the uniform resource locator (URL) of the imaging device 100. The device access information may include the network print queue address of the imaging device 100, point-and-print ports, an electronic mail address used by the imaging device 100 to monitor incoming attachments, an FTP address, an administrator-defined nickname, a hostname or the internet printing protocol (IPP) address of the imaging to device 100. Other access information for the imaging device 100 will be apparent to those skilled in the art given the benefit of this disclosure.

In some example embodiments, the device access information that may be acquired by the mobile device 140 may include data regarding the performance, operation and/or capabilities of the imaging device 100 such as supported print data streams or available device options. Print data stream formats may be, for example, PostScript, PCL or XPS. Device options may include, for example, finishing options, input options and/or device configuration data. Finishing options may include, for example, stapling, collation, hole punching or duplexing. Input options may include, for example, paper size and media type. Device configuration data may include, for example, color or monochrome printing and n-up printing. In some embodiments, the device access information may include device status information, such as ready, not ready, paper out and paper jam.

With continued reference to FIG. 2, at block 235, a printing subsystem of the mobile device 130 may be configured to communicate with the imaging device 100 in accordance with the decoded device access information acquired in block 200. The printing subsystem of the mobile device 140 when configured with the decoded device access information may allow the mobile device 140 to communicate with and send print jobs to the imaging device 100. The printing subsystem may include a network connection. In one aspect, the printing subsystem may wirelessly communicate with one or more imaging devices 100. In another aspect, the printing subsystem may communicate with other imaging devices 100 via a wired connection (e.g., a wire, cord or cable). The printing subsystem may also render one or more files into a printable format before sending the print job to an imaging device 100 for printing.

In the example embodiments where the device access information acquired by the mobile device includes data regarding the performance, operation and/or capabilities of the imaging device, the printing subsystem of the mobile device 140 may configured with such data. As used herein, the term “printing subsystem” may also refer to a printer driver or application installed in the mobile device 140.

In one example embodiment, the printing subsystem may be specific to the imaging device 100. In another example embodiment, the printing subsystem may be capable of facilitating communication between the mobile device 140 and a variety of different imaging devices or types of imaging devices. In operation, the printing subsystem to may process a print job that is generated by the mobile device 140 to the imaging device 100 and direct the imaging device 100 to print the print job.

Referring to block 235 of FIG. 2, the mobile device may be configured to communicate with the imaging device 100 in accordance with decoded device access information. Configuring the mobile device 140 may include use the access data from the decoded device information to modify the printing subsystem or the print driver of the mobile device 140 for printing using the imaging device 100. In one example embodiment, the decoded access information contains the point-and-print ports of the imaging device, and the port of the printing subsystem may be modified to enable the mobile device 140 to send print jobs to the imaging device 100.

In another example embodiment, the mobile device 140 may be configured to communicate with the imaging device 100 by accessing barcode is encoded with an e-mail address that the imaging device 100 monitors for incoming attachments. After decoding the barcode to obtain the e-mail address, the printing subsystem may be configured to send print jobs to the e-mail address as an attachment. The imaging device 100 may then receive a push notification from an e-mail service that an e-mail has been received and retrieve the document attached as a print job, and subsequently produce a printed output of the attachment.

At block 240 of FIG. 2, the mobile device 140 may now send print jobs to the imaging device 100. The print jobs may be processed through a print driver or application in the printing subsystem of the mobile device 140 associated with the imaging device 100. The print driver may be a software application that is configured to convert data to be printed into a form specific to the imaging device 100. In one alternate embodiment, the print driver may reside on the imaging device 100. It will further be appreciated that portions of the print driver may reside on both the imaging device 100 and on the mobile device 140 in some other alternate embodiments.

Once the mobile device 140 has been configured to communicate with the imaging device 100, the print jobs may be sent to and printed at the imaging device 100. For example, the printing subsystem on the mobile device 140 may invoke the print controller (not shown) and the print engine of the imaging device 100 to produce a printed output of the print jobs. The print controller may receive the print jobs from the mobile device 140 and output printed pages through the print engine. The printed pages may be a hard copy of one or more pages that a user of the mobile device 140 sent to imaging device 100 for printing. It will be appreciated that the one or more files may also be processed by the imaging device 100 in some example embodiments.

Those skilled in the art will appreciate that the device access information acquired by the mobile device 140 may be saved on a computer-readable storage medium, such as memory (not shown) of the mobile device 140 and/or the imaging device 100 for future use. In one example embodiment, the storing may occur during the configuration of the mobile device 140 at block 235. When a user of the mobile device 140 approaches a first imaging device, acquires the imaging device access information and configures the mobile device 140 to send print jobs to the imaging device, the configuration may be saved or stored for future use. The time period for maintaining this configuration information may be indefinite, based upon a predetermined time interval or set by a user.

In one aspect of this example embodiment, configuration information in the printing subsystem of the mobile device 140 may remain unchanged until the communication with the imaging device for which it is configured is no longer detected. In such aspect, the acquisition process may be repeated, and the configuration overwritten.

In another aspect of this example embodiment, configuration information for each imaging device the mobile device 140 communicates with may be stored. Thus, when the user is in closer proximity to the first imaging device instead of the second imaging device, the mobile device may automatically retrieve the configuration data of the first imaging device from its memory and set up its printing subsystem to communicate print jobs to the first imaging device instead of the second imaging device. In such aspect, the user may not need to repeat the acquisition of the device access information of the first imaging device.

In a second example embodiment, configuration information in the printing subsystem of the mobile device 140 may only be temporarily stored for a single print job. In such example embodiment, the acquisition process may need to be repeated every time the user wants to print.

FIG. 3 shows one example embodiment by which the acquiring the device access information action in block 200 of FIG. 2 may be performed (block 300). In block 205, acquiring the device access information may be performed by activating a barcode scanner in the mobile device 140 to acquire the device access information encoded into a barcode. In this example embodiment, the access information may be encoded into a high-density two-dimensional barcode such as, but not limited to, Aztec, PDF417, DataMatrix or Quick Response (QR) Code, using any of a number of bar code encoding techniques. In some example embodiments, the access information may be encoded into a one-dimensional barcode such as, but not limited to, Code 128, Databar, Code 39 or Code 93, using any of a number of bar coding techniques.

In one aspect of this example embodiment, a user may activate the barcode display application 125 by making a selection using the input device 110 on the imaging device 100. In another aspect, the user may activate the barcode display activation by making a selection on the user interface 120. Once the barcode display application 125 is activated or invoked, the barcode containing the device access information may be displayed in the communications interface 120. In some embodiments, the device access information may be encoded dynamically.

In another aspect of the first example embodiment, the barcode containing the device access information may be printed on a media 105 using the imaging device 100 once the barcode display application 125 is activated or invoked. In another aspect, a user of the imaging device 100 may acquire the barcode by activating the control unit of the imaging device 100 to print the barcode. The barcode may be printed on demand or pre-printed.

In still another aspect of the first example embodiment, a user or administrator of an imaging device that does not have a barcode display application 120 may configure the imaging device 100 to print a copy of the barcode containing the device access information on any media, such as paper, a label or a sticker 115 that may be visually displayed on the imaging device 100. In some example embodiments, the media containing the device access information may be physically handed out to other users of mobile devices who desire to print to the imaging device 100.

At block 210 of FIG. 3, the mobile device 140 may read the visually displayed barcode via a barcode scanner. Reading the barcode may include capturing an image of the barcode using a camera on the mobile device 140 or any device that can capture an image of a visually displayed barcode. The image may then be scanned or interpreted using the barcode scanner installed in the mobile device 140 in order to extract the device access to information from the barcode (block 215 of FIG. 3). In an alternate example embodiment, a barcode recognition device may be activated in the mobile device 140 to scan and decode the barcode without capturing an image of the barcode. It will be appreciated by one of ordinary skill in the art that a barcode scanning device may also be used to acquire the device access information in lieu of a barcode scanner application in the mobile device 140. Other methods of reading a barcode will also be apparent to those skilled in the art given the benefit of this disclosure.

At block 215 of FIG. 3, the mobile device 140 may extract from or decode the barcode to obtain the device access information. Interpreting the barcode may include decoding the access information encoded in the barcode to obtain the access data. Such access information may include but is not limited to, the IP address, hostname or the nickname of the imaging device 100. In one example embodiment, if the access data contains an imaging device nickname, a mobile device application or custom print driver in the mobile device 140 may perform a database or table lookup to obtain the corresponding IP address, hostname or any other network identifier of the imaging device 100 in accordance with the obtained imaging device nickname. As described above, the access data may further include the network print queue address of the imaging device, point-and-print ports, e-mail address that the imaging device may use to monitor incoming attachments, the FTP address, administrator-defined nickname, hostname or the internet printing protocol (IPP) address of the imaging device. Other access data for the imaging device 100 will be apparent to those skilled in the art given the benefit of this disclosure.

FIG. 4 shows a second example embodiment by which acquiring the device access information in block 200 of FIG. 2 may be performed (block 400). In block 220, acquiring device access information may be performed by activating a radio frequency identification (RFID) scanner application in the mobile device 140 to obtaining the device access information for the imaging device 100. In this example embodiment, the device access information may be encoded in an RFID tag 130 that may be associated with or attached to the imaging device 100. RFID-based device access information may be created using any RFID programming device to program the RFID tag 130 to include the device access information. The RFID tag 130, if not already embedded in a suitable object, may then be attached to any object. The RFID-based device access information may be embedded into or physically attached to the imaging device 100.

At block 225 of FIG. 4, the mobile device may read the RFID tag 130 using the RFID scanner of the mobile device 140. In one aspect of the second example embodiment, reading and acquiring the device access information may occur automatically as the user approaches the imaging device 100. It will be appreciated by one of ordinary skill in the art that an RFID scanning device may be used to acquire the device access information in lieu of an RFID scanner application in the mobile device 140.

Once the mobile device 140 recognizes the RFID tag, the access information may be decoded to obtain the data needed to access the imaging device 100. At block 230, an application or custom driver in the mobile device 140 may extract and decode access data from the RFID tag 130. Such access information or data may include the IP address, the host name or the nickname of the imaging device. In one example embodiment, if the decoded access information contains the nickname of the imaging device 100, a mobile device application or custom print driver may perform a database or table lookup to obtain the corresponding IP address, hostname or any network identifier of the imaging device 100. As described above, the access data may further include the network print queue address of the imaging device, point-and-print ports, e-mail address that the imaging device may use to monitor incoming attachments, the FTP address, administrator-defined nickname, hostname or the internet printing protocol (IPP) address of the imaging device. Other access information for the imaging device 100 will be apparent to those skilled in the art given the benefit of this disclosure.

It will be appreciated that the actions described and shown in the example flowcharts may be carried out or performed in any suitable order. It will also be appreciated that not all of the actions described in FIGS. 2, 3 and 4 needs to be performed in accordance with the embodiments of the disclosure and/or additional actions may be performed in accordance with other embodiments of the disclosure.

Many modifications and other embodiments of the disclosure set forth herein will come to mind to one skilled in the art to which these disclosure pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for configuring a mobile device, comprising:
retrieving an encoded access information from an imaging device;
decoding the encoded access information; and
configuring the mobile device to communicate with the imaging device in accordance with the decoded access information.

2. The method of claim 1, wherein the imaging device and the mobile device are operating on different subnets of a network.

3. The method of claim 1, wherein the encoded access information is retrieved from a barcode.

4. The method of claim 1, wherein the barcode is in a QR barcode.

5. The method of claim 1, wherein the barcode is displayed on the imaging device.

6. The method of claim 1, wherein the barcode is printed on a media.

7. The method of claim 1, wherein the encoded access information includes an imaging device network identifier.

8. The method of claim 1, wherein the encoded access information includes an imaging device name.

9. The method of claim 7, further comprising performing a database lookup to obtain the imaging device network identifier if the encoded access information includes the imaging device name.

10. The method of claim 1, wherein the decoding the encoded access information comprises extracting the imaging device network identifier.

11. The method of claim 1, wherein the encoded access information includes an imaging device status.

12. The method of claim 1, wherein the encoded access information includes an imaging device option.

13. The method of claim 1, wherein the encoded access information includes an imaging device configuration data.

14. The method of claim 1, wherein the encoded access information retrieved from an RFID tag.

15. A non-transitory computer-readable storage medium containing computer executable instructions to:
acquire an imaging device access information;
interpret the imaging device access information; and
configure a mobile device to communicate with an imaging device in accordance with the imaging device access information.

16. The non-transitory computer-readable storage medium of claim 15, wherein the imaging device access information comprises information identifying a network location of the imaging device.

17. The non-transitory computer-readable storage medium of claim 15, wherein the imaging device access information comprises a nickname of the imaging device.

18. The non-transitory computer-readable storage medium of claim 15, further comprising an instruction to perform a database lookup to obtain the network location of the imaging device if the imaging device access information includes the nickname of the imaging device.

19. The non-transitory computer-readable storage medium of claim 15, wherein the configuring the mobile device to communicate with the imaging device comprises modifying a port of the mobile device.

20. The non-transitory computer-readable storage medium of claim 15, wherein the imaging device access information is stored in a barcode.
